(19) United States
(12) Patent Application Publication
(10) Pub. No.: US 2017/0361892 A1
(43) Pub. Date: Dec. 21, 2017

(54) SCOOTER WITH MECHANICAL ASSEMBLIES

(71) Applicant: EDGE BRANDS LTD., Rehoboth, MA (US)

(72) Inventor: Thomas J. O'Rourke, Harlingen, TX (US)

(21) Appl. No.: 15/535,099

(22) PCT Filed: Dec. 11, 2015
(86) PCT No.: PCT/US2015/065251

§ 371 Date: Jun. 12, 2017

Related U.S. Application Data
(60) Provisional application No. 62/090,793, filed on Dec. 11, 2014.

(51) Int. Cl. B62K 3/00; B62M 1/00; A63B 71/00; B62K 17/00

(52) U.S. Cl. CPC B62K 3/002; B62M 1/00; A63B 71/00; B62K 17/00

(57) ABSTRACT

A scooter is provided. The scooter may include a front wheel assembly, a pair of connector elements, and a pair of rear wheel caster assemblies. The pair of connector elements may be cooperable with the front wheel assembly for lateral movement relative thereto. Each of the pair of rear wheel caster assemblies may be secured to a rear portion of one of the connector elements and may have a caster defining a caster axis and a rear wheel mounted for rotation to the caster. The front wheel assembly and connector elements may be arranged with one another such that adjustment of a height of a front portion of each of the connector elements adjusts an angle of the respective caster axis relative to an underlying surface. The scooter may include a lock mechanism to selectively engage the connector elements and to facilitate transition between multiple types of scooter movement.

### CROSS-REFERENCE TO RELATED APPLICATION

This application claims the benefit of U.S. provisional application Ser. No. 62/090,793 filed Dec. 11, 2014, the disclosure of which is hereby incorporated in its entirety by reference herein.

### TECHNICAL FIELD

The present disclosure relates to user powered propulsion scooters and assemblies to facilitate scooter reconfiguration.

### BACKGROUND

Propulsion scooters are used for recreation, fitness, and transportation. These scooters typically take advantage of a resultant force that may be gained by a repetitive single user motion in combination with an appropriate mechanical configuration of the scooter. The fitness benefits of the repetitive single user motion, however, may be limited due to a focus on a one particular group of muscles. The repetitive single user motion may also become monotonous which may deteriorate enjoyment of the scooter. Improvements to mechanics of propulsion scooters are desired to provide expanded fitness benefits while also improving efficiency of the scooter mechanical configurations to improve performance and enjoyment for the user.

### SUMMARY

According to an embodiment, a scooter includes a front wheel assembly, a pair of connector elements, and a pair of rear wheel caster assemblies. The front wheel assembly has a front wheel. The pair of connector elements is cooperable with the front wheel assembly for lateral movement relative thereto. Each of the pair of rear wheel caster assemblies is secured to a rear portion of one of the connector elements. Each of the pair of rear wheel caster assemblies has a caster defining a caster axis and a rear wheel mounted for rotation to the caster. The front wheel assembly and connector elements are arranged with one another such that adjustment of a height of a front portion of each of the connector elements adjusts an angle of the respective caster axis relative to an underlying surface. The front wheel may be mounted to the front wheel assembly for camber movement between at least a first camber position and a second camber position. The front wheel assembly and connector elements may be arranged with one another such that adjustment of the camber of the front wheel between the first and second camber positions adjusts an angle of the caster axis relative to an underlying surface. A steering column may extend from the front wheel assembly and may be arranged such that application of a lateral force to the steering column adjusts the angle of the caster axis to adjust a torque distribution to the connector elements. The steering column may be arranged with the front wheel assembly such that application of a lateral force to the steering column adjusts a height of at least a portion of the connector elements relative to an underlying surface. The connector elements may be arranged with the front wheel assembly such that the adjustment in height varies an amount of energy generated by a weight of a user thereon to generate swizzle propulsion. Swizzle propulsion may be defined as a propulsion generated by vertical movement of the connector elements relative to the underlying surface while one or more lateral forces are applied to the connector elements. The rear wheel caster assemblies are mounted to the respective connector element such that alternating lateral forces applied to the connector elements by a user propels the scooter in a generally forward direction. Each of the rear wheels may be mounted to the respective rear wheel caster assembly in a fixed orientation for rotation to generate camber propulsion when lateral forces are applied to the connector elements. The front wheel assembly may include a body defining at least two notches. One of the connector elements may include a fastener sized for selective mating with the notches such that the connector element may be secured to the front wheel assembly in at least two positions.

According to an embodiment, a scooter includes a front wheel assembly, a rider support assembly, a pair of rear wheel caster assemblies, and an engagement mechanism. The front wheel assembly includes a yoke. The rider support assembly includes a pair of connector elements mounted for pivotal movement to the yoke. Each of the rear wheel caster assemblies is mounted to one of rear portions of the connector elements. The engagement mechanism is cooperable with the yoke and connector elements to secure the connector elements in at least a first position and a second position. The connector elements are arranged with the engagement mechanism to operate in a scissor movement when in the first position and a sway movement in the second position. The engagement mechanism may include a first and second fastener assembly each of which comprises a sleeve member defining a cavity sized to receive a portion of the respective connecter element and a portion of the yoke. The first and second fastener assembly may be mounted to the connector element for translation along a connector axis defined by the connector element such that the sleeve member prevents scissor movement of the respective connector element in the second position. Each of the sleeve members may be mounted to the connector element for rotation about the connector axis and may define a notch sized to receive a hitch extending from the respective connector element or yoke to secure the sleeve member in the first position or second position. The scissor movement may be further defined by movement of the connector elements in directions opposite one another in a scissor-like manner. The scissor movement may be further defined by movement of the connector elements in which an angle defined therebetween changes during the movement. The sway movement may be further defined by movement of the connector elements in a same direction. The sway movement may be further defined by movement of the connector elements in which an angle defined therebetween remains constant during the movement. The connector elements may be arranged with the front wheel assembly such that different muscles of a user drive the scissor movement in comparison to the sway movement.

According to an embodiment, a reconfigurable scooter includes a front wheel assembly, a steering column, first and second connector elements, and a lock mechanism. The steering column is operably connected to the front wheel assembly. Each of the first and second connector elements are mounted at a first end to the front wheel assembly for selective pivotal movement. The lock mechanism is operably connected to and arranged with the first and second connector elements to engage and disengage such that the first and second connector elements selectively engage for sway movement and selectively disengage for scissor movement. The lock mechanism may include first and second engagement members each sized for mounting to one of the first connector element and the second connector element and for translation along a connector axis defined by the respective connector element. The engagement members may be sleeve members in which each sleeve member defines a notch sized to receive a hitch extending from the respective connector element. The sleeve members may be mounted to the respective connector element for rotation about the connector axis. The first and second engagement members may be sized to translate along a connector axis defined by the respective connector element between at least a first position for the sway movement and a second position for the scissor movement.

According to an embodiment, a scooter includes a front wheel assembly with a front wheel, a pair of connector element assemblies, and a pair of rear wheel. Each of the pair of connector element assemblies are connected for movement to the front wheel assembly such that camber of the front wheel between at least a first camber position and a second camber position relative to the connector elements causes the connector elements to raise and lower relative to an underlying support surface. Each of a pair of subframes extends from one of the pair of connecting elements. Each of the pair of rear wheel caster assemblies are each secured to a rear portion of one of the connector elements with a caster defining a caster axis, and a rear wheel mounted for rotation to the caster. The movement of the connector elements adjusts an angle of the caster axis relative to an underlying surface.

According to embodiment, a scooter includes a front wheel assembly with a yoke, a rider support assembly, a pair of rear wheel caster assemblies, and a lock mechanism. The rider support assembly has a pair of connector elements mounted for pivotal movement to the yoke. Each of the pair of rear wheel caster assemblies are each secured to a rear portion of one of the connector elements. The lock mechanism is arranged with the connector elements and yoke such that the lock mechanism prevents pivotal movement of the connector elements in an engaged position and the connector elements pivot freely in a disengaged position. The connector elements permit sway propulsion when the lock mechanism is in the engaged position and scissor propulsion when the lock mechanism is in the disengaged position.

### BRIEF DESCRIPTION OF THE DRAWINGS

FIG. 1 is a perspective view of an example of a scooter.

FIG. 2 is a detailed perspective view of a portion of the scooter of FIG. 1 showing an example of a lock mechanism assembly in a first position.

FIG. 3 is a detailed perspective view of the lock mechanism of FIG. 2 showing the lock mechanism in a second position.

FIG. 4 is a detail perspective view of a rear wheel assembly of the scooter of FIG. 1.

FIG. 5 is a plan view of the scooter of FIG. 1 showing examples of lateral forces which may be applied to connector elements of the scooter.

FIG. 6 is a plan view of the scooter of FIG. 1 shown in a first configuration.

FIG. 7 is a plan view of the scooter of FIG. 1 shown in a second configuration.

FIGS. 8A through 8C are a front view of an example of a front wheel assembly of the scooter of FIG. 1 showing three examples of camber positions of the front wheel assembly.

FIG. 9 is a side view of the scooter of FIG. 1 showing an example of a caster assembly axis oriented at a first angle relative to an underlying surface.

FIG. 10 is a side view of the scooter of FIG. 1 showing an example of the caster assembly axis of FIG. 9 oriented at a second angle relative to the underlying surface.

FIG. 11 is a perspective view of an example of portions of a front assembly and connector elements of a scooter.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ embodiments of the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

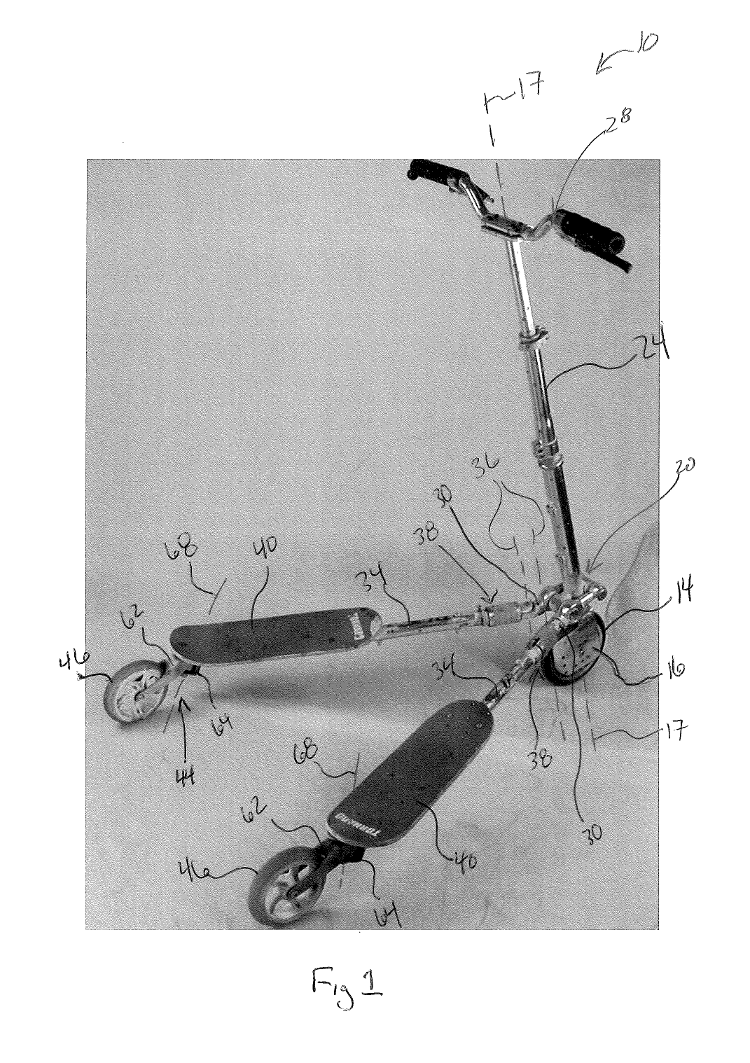

FIG. 1 shows an example of a scooter assembly, referred to generally as a scooter 10 herein. The scooter 10 may include a front wheel 14 mounted for rotation to a bracket 16. The bracket 16 may be mounted to a yoke 20. A steering column 24 may extend through a cavity defined by the yoke 20 and be secured to the bracket 16 such that front wheel 14 and steering column 24 rotate together about a column axis 17. The column axis 17 may be defined by a central axis of the steering column 24 and a central portion of the front wheel 14. The column axis 17 may be oriented at various angles relative to an underlying surface to obtain different performance results. It is contemplated that the column axis 17 may be oriented at various angles relative to the underlying surface. A handle bar assembly 28 may be secured to the steering column 24. A pair of extension members 30 may extend from the yoke 20. Each of the extension members 30 may be configured for pivotal attachment to a forward end of one of a pair of connector elements 34 such that the connector elements 34 may pivot laterally about a first pivot axis 36. The first pivot axis 36 may be substantially parallel to the column axis 17. A lock mechanism assembly, such as a pair of lock mechanism assemblies 38, may be arranged with the extension members 30 and the corresponding connector element 34 to selectively move between an engaged and disengaged position. For example, in the engaged position, each lock mechanism assembly 38 may prevent pivotal movement of the respective connector elements 34 and in the disengaged position the connector elements 34 may pivot freely.

A pair of supporting platforms, such as decks 40, may be secured to the scooter 10 and configured to support a user. Each of the decks 40 may be secured at a rearward end of the corresponding connector element 34. It is contemplated that connector elements 34 are also suitable to support a user's feet. A pair of caster assemblies 44 each may be mounted at the rearward end of one of the connector elements 34. A pair of rear wheels 46 may be mounted for rotation to the corresponding caster assembly 44 such that the front wheel 14 and the rear wheels 46 support the scooter 10 on the underlying surface.

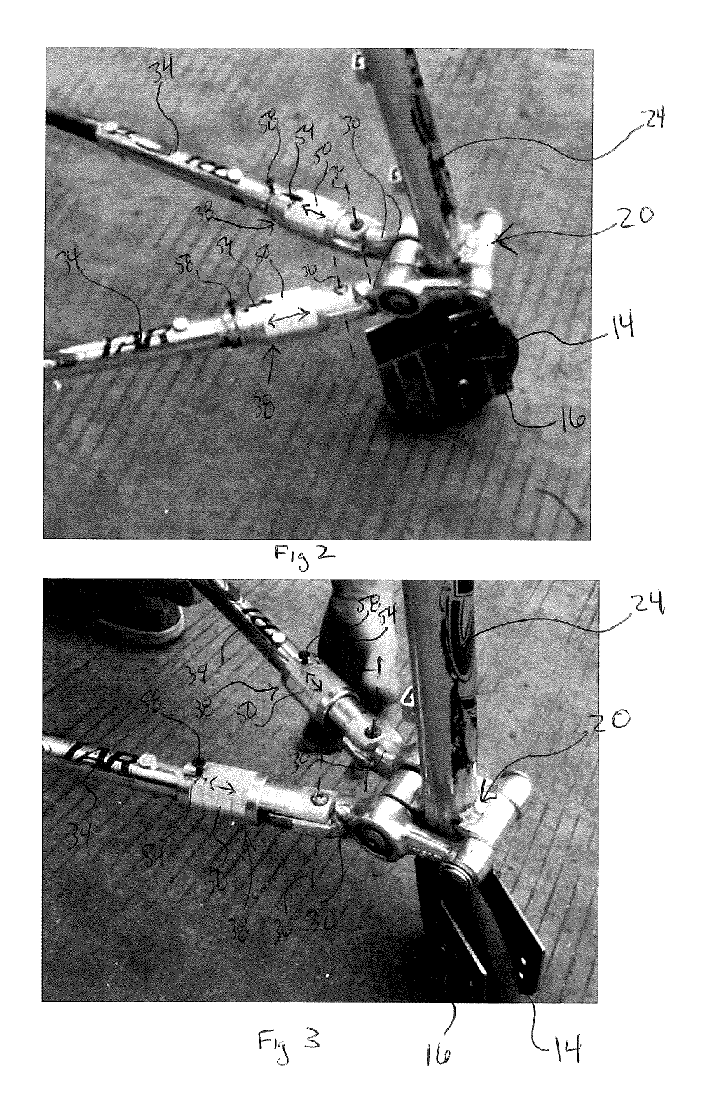

FIGS. 2 and 3 show an example of two positions of the lock mechanism assemblies 38. Multiple fastener assemblies may be used with the lock mechanism assemblies 38 to facilitate engagement and disengagement of the extension members 30 and the connector elements 34. In one example, each lock mechanism assembly 38 includes a sleeve member 50 defining a cavity sized to receive a portion of the respective extension member 30 and a portion of the respective connector element 34 such that the sleeve member 50 may rotate about and translate along the connector element 34 and between the engaged position (shown in FIG. 2) and the disengaged position (FIG. 3). Each of the sleeve members 50 may define a notch 54 sized to receive a hitch 58 such that the notch 54 and the hitch 58 may be arranged with one another to secure the lock mechanism assembly 38 in the disengaged position. A rear portion of the sleeve member 50 may rest against the hitch 58 in the disengaged position to assist in preventing translation of the sleeve member 50 along the connector element 34.

FIG. 4 shows an example of one of the caster assemblies 44. Each caster assembly 44 may include a wheel bracket 62 and a swivel caster 64. The respective rear wheel 46 may be mounted for rotation to the respective wheel bracket 62. The swivel caster 64 may be mounted to the rear portion of the respective connector element 34 or to an underside of the respective deck 40. The wheel bracket 62 and the swivel caster 64 may be arranged with one another such that the wheel bracket 62 pivots about a caster axis 68. The swivel caster assembly 44 is one example of a wheeled support assembly which may be used to generate propulsion for the scooter 10 as further described herein. The swivel casters 64 may be mounted at an acute angle relative to a rear portion of the scooter 10 as shown by the caster axis 68 in FIG. 4.

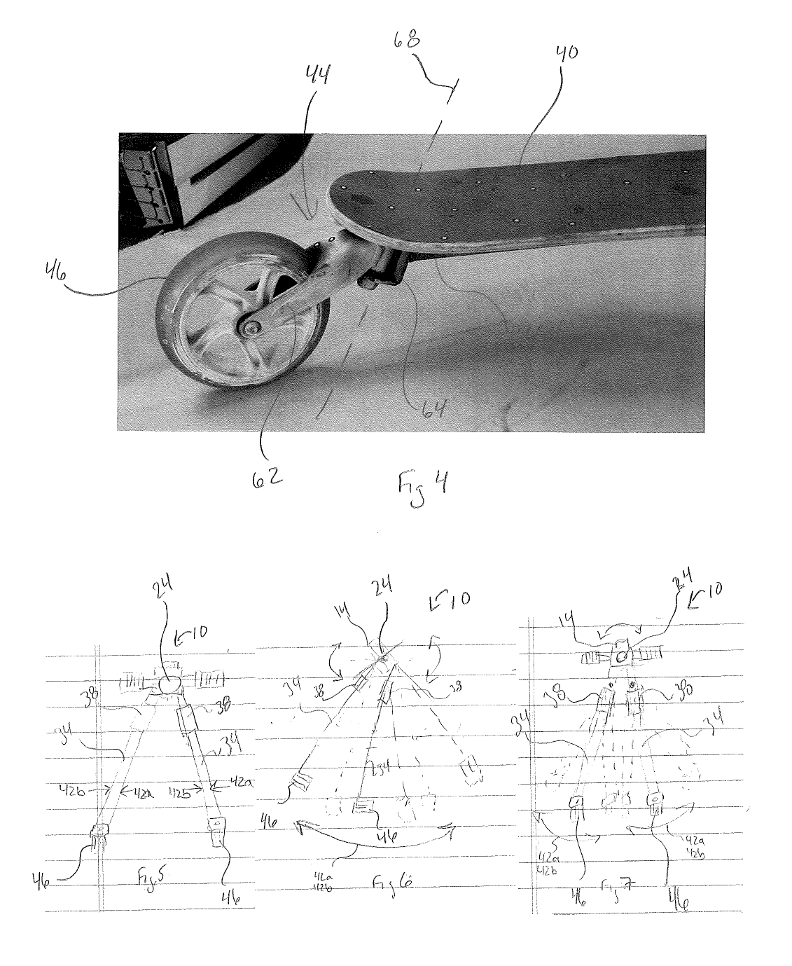

For example, the orientation of the swivel casters 64 at the acute angle may be such that the rear wheels 46 turn on the swivel casters 64 and raise the decks 40 when lateral forces are introduced to the decks 40 via energy transferred from legs of a user. In this example, applying first lateral forces (represented by force arrow 42a in FIG. 5) in excess of an amount of force required to turn the swivel casters 64 may be converted into motion as the rear wheels 46 react to the first lateral forces and roll. Energy stored from a weight of the user as the decks 40 raise under application of the first lateral forces may be released when second lateral forces (represented by force arrows 42b in FIG. 5) are applied in a direction opposite the first lateral forces. Thus, the decks 40 may move up and down with subsequent applications of the lateral forces. The resulting propulsion of the scooter 10 may be referred to as swizzle propulsion herein. The swizzle propulsion may be considered similar to that of a fish as the fish swings a tail from side to side.

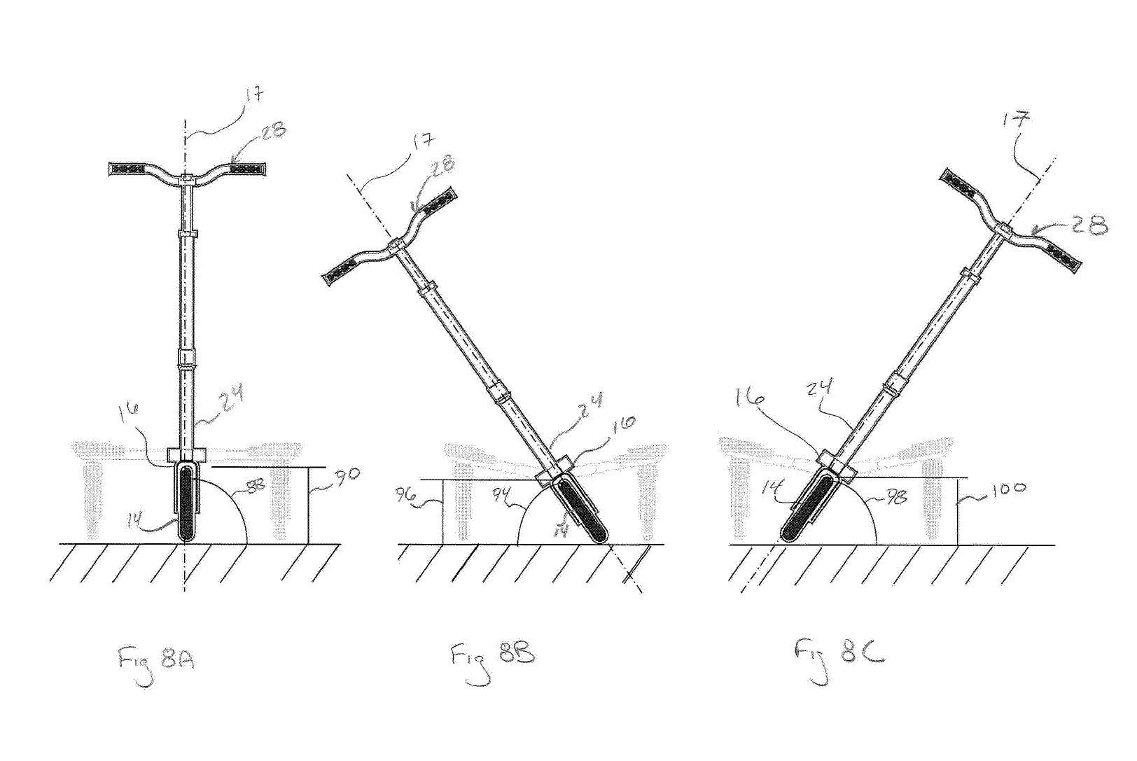

Sway propulsion and scissor propulsion may be considered two subcategories of swizzle propulsion. The scooter 10 may be reconfigurable between two configurations to facilitate sway propulsion and scissor propulsion. For example, the scooter 10 may be reconfigurable between a sway configuration as shown in FIG. 6 and a scissor configuration as shown in FIG. 7. In the sway configuration, the lock mechanism assemblies 38 may be in the engaged position as described above. The user may move their feet in the same direction and from side to side to exert lateral forces to achieve the sway propulsion. This side to side movement may be facilitated by a user's glutes and oblique muscles. In the scissor configuration, the lock mechanism assemblies 38 may be in the disengaged position such that the connector elements 34 may pivot as described above. The user may move their feet in opposite directions from side to side such that the feet are either moving toward or away from one another in a scissor motion. This opposing side to side movement may be facilitated by the user's thigh, abdominal, and hamstring muscles. As such, the user may reconfigure the scooter 10 between the sway configuration and the scissor configuration to provide alternative riding options and fitness routines which exercise multiple muscle groups.

With both sway propulsion and scissor propulsion, an amount of energy required by the user to execute the side to side movement of the decks 40 may be directly proportionate to an angle of the caster axis 68 relative to the underlying surface. For example, as the angle of the caster axis 68 moves closer to a ninety degree angle relative to the underlying surface, the side to side movement becomes less strenuous as torque increases and thus less speed is generated. Conversely, as the angle of the caster axis 68 moves closer to a zero degree angle relative to the underlying surface, torque decreases but more speed may be generated. As such, an angle of the caster axis 68 closer to ninety degrees may be more desirable when starting from a rest position due to higher torque, but then a user may encounter speed limitations as a result.

Another example of propulsion may be referred to as camber propulsion herein. Scooters utilizing camber propulsion, referred to as camber scooters herein, operate in a similar fashion to scooters utilizing sway propulsion with a few differences. For example, rear wheel brackets of camber scooters may be fixed to corresponding decks instead of mounted via a swivel caster assembly. Further, a yoke of a camber scooter may be elastically attached to connector elements to facilitate a cambering movement of a steering column arranged with the yoke. For example, the cambering movement of the steering column may adjust an angle of a front wheel mounted for rotation thereto such that an angle of the front wheel relative to an underlying surface increases or decreases when a user leans on the steering column, for example, to the left or right. The increase or decrease of the angle of the front wheel may assist in generating propulsion of the camber scooter.

For example, the user may camber or tilt the steering column as the user shifts their weight from one side to another. As the front wheel cambers in either direction from a central position, a distance between the connecting elements and the underlying surface is reduced. The weight and a thrust of the user leaning against the steering column may cause this reduction in distance and create angular momentum. The angular momentum may be conserved and redirected when the user cambers the steering column in the opposite direction. Propulsion gained is due to conservation of the angular momentum and may be proportionate to a percentage of the user's weight committed to the cambering thrust. One example of a drawback to the camber scooter is that a user may need to execute significant or dramatic movements to generate enough force via weight distribution to generate a desirable amount of propulsion. However, combining certain aspects of camber scooters and swizzle scooters into one unit may provide a user with benefits from both.

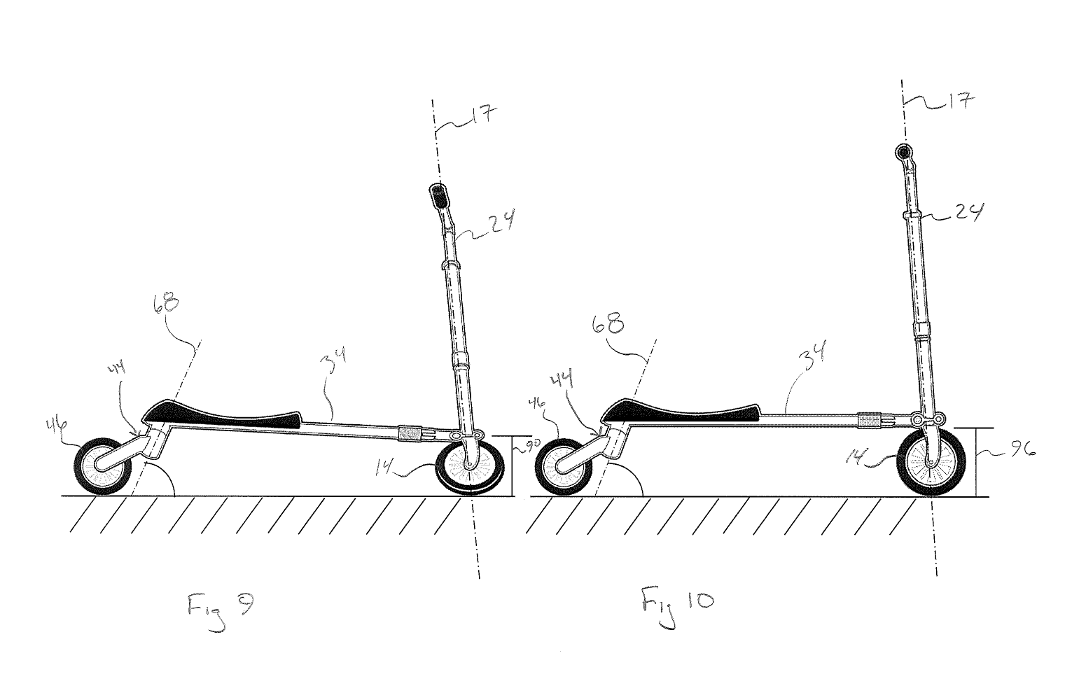

For example, the scooter 10 may include components to facilitate camber propulsion and swizzle propulsion in both the sway configuration and the scissor configuration of the scooter 10. In this example, the yoke 20 may be elastically attached to the connector elements 34 to facilitate a cambering movement of the steering column 24 and the front wheel 14. FIGS. 8A through 8C show an example of three positions of the front wheel 14 and the steering column 24 in which the column axis 17, and thus the front wheel 14, is oriented at different angles relative to the underlying surface.

In FIG. 8A, the front wheel 14 is shown in a central position in which the column axis 17 is oriented at an angle 88 of substantially ninety degrees relative to the underlying surface. A distance from the underlying surface to an upper portion of the front wheel 14 is defined as a first distance 90 when no camber is being applied. The first distance 90 may also be referred to as a maximum distance from the underlying surface.

In FIG. 8B, the front wheel 14 is shown in an example of a first cambered position in which the column axis 17 is oriented at an angle 94 relative to the underlying surface. In one example, the angle 94 may be less than ninety degrees and greater than forty five degrees. A distance from the underlying surface to the upper portion of the front wheel 14 is defined as a second distance 96 in which an example of a camber is being applied.

In FIG. 8C, the front wheel 14 is shown in an example of a second cambered position in which the column axis 17 is oriented at an angle 98 relative to the underlying surface. In one example, the angle 98 may be less than ninety degrees and greater than forty five degrees. A distance from the underlying surface to the upper portion of the front wheel 14 is defined as a third distance 100 in which another example of a camber is being applied. Both the second distance 96 and the third distance 100 are less than the first distance 90.

As such, forward portions of the connector elements 34 are closer to the underlying surface when a camber is applied to the front wheel 14 in comparison to the front wheel 14 being in the central position. As the forward portion of the connector elements 34 lower toward the underlying surface, rear portions of the connector elements 34, and the corresponding caster assembly 44 secured thereto, tilt forward and adjust an angle of the caster axis 68 relative to the underlying surface.

For example, FIGS. 9 and 10 show an example of two connector element 34 positions and an example of two caster axis 68 angles resulting from the orientations of the connector elements 34. Takeoffs and/or starts of the scooter 10 may be preferred in the scooter 10 configuration shown in FIG. 9 in which the front wheel 14 is in the central position since the caster axis 68 is more perpendicular to the underlying surface in comparison with the scooter 10 configuration shown in FIG. 10. As momentum is gained following the takeoff, a user may implement the camber to the front wheel 14 to adjust the caster axis 68 to a more acute angle shown in FIG. 10 in comparison with the caster axis 68 as shown in FIG. 9 to increase a potential amount of speed the caster assemblies 44 may generate. The scooter 10 may thus provide multiple propulsion options which may provide multiple fitness options to exercise various muscles of the user and also provides propulsion options such that the user may improve propulsion efficiency under various conditions such as up/down grades, longer distances, speed, or close quarter riding. For example, with typical swizzle propulsion some energy may be lost when force is exerted by a user's arms against a steering column and absorbed without any propulsion benefit. With typical camber propulsion some energy may be lost when force is exerted by a user's legs against rear wheels of the scooter and absorbed without any propulsion benefit. The scooter 10 takes advantage of both swizzle propulsion and camber propulsion to generate a more efficient force to thrust ratio, less muscle fatigue, a more complete fitness regimen, and greater entertainment potential.

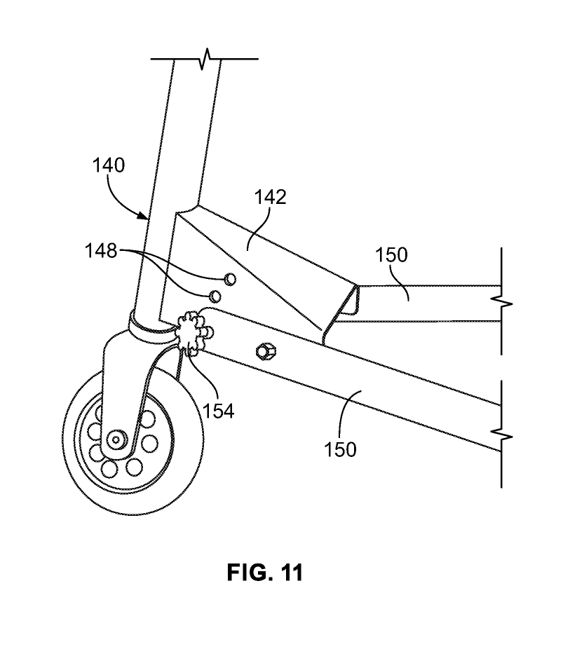

FIG. 11 shows another example of portions of a front assembly and connector elements for a scooter. A front assembly 140 may include a body 142 defining a plurality of notches 148. The notches 148 may be defined on both sides of the body 142 though only one side of the body 142 is shown in FIG. 11. A pair of connector elements 150 may be secured to the body 142. For example, a fastener 154 may be mounted to the connector element 150. The fastener 154 may be sized for selectively mating with the notches 148 such that the connector element 150 may be secured to the front assembly 140 in at least two positions to adjust a height of the connector element 150 relative to an underlying surface. As such, an angle of an axis of a caster assembly (not shown) secured to each of the connector elements 150 may be adjusted relative to the underlying surface.

While various embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to marketability, appearance, consistency, robustness, customer acceptability, reliability, accuracy, etc. As such, embodiments described as less desirable than other embodiments or prior art implementations with respect to one or more characteristics are not outside the scope of the disclosure and can be desirable for particular applications.

What is claimed is:

1. A scooter comprising:
a front wheel assembly with a front wheel;
a pair of connector elements cooperable with the front wheel assembly for lateral movement relative thereto; and
a pair of rear wheel caster assemblies, each secured to a rear portion of one of the connector elements, each with a caster defining a caster axis, and each with a rear wheel mounted for rotation to the caster,
wherein the front wheel assembly and connector elements are arranged with one another such that adjustment of a height of a front portion of each of the connector elements adjusts an angle of the respective caster axis relative to an underlying surface.

2. The scooter of claim 1, wherein the front wheel is mounted to the front wheel assembly for camber movement between at least a first camber position and a second camber position, and wherein the front wheel assembly and connector elements are arranged with one another such that adjustment of the camber of the front wheel between the first and second camber positions adjusts an angle of the caster axis relative to an underlying surface.

3. The scooter of claim 2, further comprising a steering column extending from the front wheel assembly, and arranged such that application of a lateral force to the steering column adjusts the angle of the caster axis to adjust a torque distribution to the connector elements.

4. The scooter of claim 2, further comprising a steering column extending from the front wheel assembly, wherein the steering column is arranged with the front wheel assembly such that application of a lateral force to the steering column adjusts a height of at least a portion of the connector elements relative to an underlying surface.

5. The scooter of claim 4, wherein the connector elements are arranged with the front wheel assembly such that the adjustment in height varies an amount of energy generated by a weight of a user thereon to generate swizzle propulsion.

6. The scooter of claim 5, wherein swizzle propulsion is defined as a propulsion generated by vertical movement of the connector elements relative to the underlying surface while one or more lateral forces are applied to the connector elements.

7. The scooter of claim 2, wherein the rear wheel caster assemblies are mounted to the respective connector element such that alternating lateral forces applied to the connector elements by a user propels the scooter in a generally forward direction.

8. The scooter of claim 2, wherein each of the rear wheels is mounted to the respective rear wheel caster assembly in a fixed orientation for rotation to generate camber propulsion when lateral forces are applied to the connector elements.

9. The scooter of claim 1, wherein the front wheel assembly further comprises a body defining at least two notches, and wherein one of the connector elements comprises a fastener sized for selective mating with the notches such that the connector element may be secured to the front wheel assembly in at least two positions.

10. A scooter comprising:
a front wheel assembly with a yoke;
a rider support assembly with a pair of connector elements mounted for pivotal movement to the yoke;
a pair of rear wheel caster assemblies, each of the rear wheel caster assemblies mounted to one of rear portions of the connector elements; and
an engagement mechanism cooperable with the yoke and connector elements to secure the connector elements in at least a first position and a second position,
wherein the connector elements are arranged with the engagement mechanism to operate in a scissor movement when in the first position and a sway movement in the second position.

11. The scooter of claim 10, wherein the engagement mechanism further comprises a first and second fastener assembly each of which comprises a sleeve member defining a cavity sized to receive a portion of the respective connecter element and a portion of the yoke and mounted to the connector element for translation along a connector axis defined by the connector element such that the sleeve member prevents scissor movement of the respective connector element in the second position.

12. The scooter of claim 11, wherein each of the sleeve members is mounted to the connector element for rotation about the connector axis and defines a notch sized to receive a hitch extending from the respective connector element or yoke to secure the sleeve member in the first position or second position.

13. The scooter of claim 10, wherein the scissor movement is further defined by movement of the connector elements in directions opposite one another in a scissor-like manner.

14. The scooter of claim 10, wherein the scissor movement is further defined by movement of the connector elements in which an angle defined therebetween changes during the movement.

15. The scooter of claim 10, wherein the sway movement is further defined by movement of the connector elements in a same direction.

16. The scooter of claim 10, wherein the sway movement is further defined by movement of the connector elements in which an angle defined therebetween remains constant during the movement.

17. The scooter of claim 10, wherein the connector elements are arranged with the front wheel assembly such that different muscles of a user drive the scissor movement in comparison to the sway movement.

18. A reconfigurable scooter comprising:
a front wheel assembly;
a steering column operably connected to the front wheel assembly;
first and second connector elements each mounted at a first end to the front wheel assembly for selective pivotal movement; and
a lock mechanism operably connected to and arranged with the first and second connector elements to engage and disengage such that the first and second connector elements selectively engage for sway movement and selectively disengage for scissor movement.

19. The scooter of claim 18, wherein the lock mechanism comprises first and second engagement members each sized for mounting to one of the first connector element and the second connector element and for translation along a connector axis defined by the respective connector element.

20. The scooter of claim 19, wherein the engagement members are sleeve members in which each sleeve member defines a notch sized to receive a hitch extending from the respective connector element, and wherein the sleeve members are mounted for rotation about the connector axis.

21. The scooter of claim 19, wherein the first and second engagement members are sized to translate along a connector axis defined by the respective connector element between at least a first position for the sway movement and a second position for the scissor movement.
